(19) United States
(12) Patent Application Publication
(10) Pub. No.: US 2009/0261682 A1
(43) Pub. Date: Oct. 22, 2009

(54) STATOR OF ROTATING ELECTRIC MACHINE, AND COMPONENT FOR USE IN STATOR

(75) Inventors: Shingo Fubuki, Aichi-ken (JP); Kenji Harada, Aichi-ken (JP); Yasuji Taketsuna, Aichi-ken (JP); Yuya Takano, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/296,354

(22) PCT Filed: Apr. 11, 2007
(86) PCT No.: PCT/JP2007/058389

§ 371 Date: Oct. 7, 2008

(30) Foreign Application Priority Data
Apr. 24, 2006 (JP) 2006-119373

(51) Int. Cl. H02K 3/12; H02K 3/50; H02K 3/487

(52) U.S. Cl. 310/201; 310/214

(57) ABSTRACT

A coil sub-assy includes a coil plate which has an insulating film attached to at least one side thereof and an “I”-shaped portion to be inserted into a slot of a stator core. The plurality of coil plates forming coils of an identical phase are laminated in a thickness direction of the “I”-shaped portion. The coil plates opposite to each other are formed such that a shortest distance between end faces of the “I”-shaped portions in a width direction is longer than a shortest distance between end faces of the “I”-shaped portions in the thickness direction.

### TECHNICAL FIELD

The present invention relates to a stator of a rotating electric machine, and a component for use in the stator. In particular, the present invention relates a stator having a structure for improvement of an insulating property, and a structure of a component for use in the stator.

### BACKGROUND ART

As a stator of a rotating electric machine including such stator and a rotor, conventionally, there has been disclosed a stator having a configuration that an integral laminated coil is inserted into a slot formed between two teeth provided in a stator core. The integral laminated coil has a configuration that two sets of coil laminates, each including a plurality of laminated straight sheet conductors, are integrally formed by resin molding. The sheet conductors are laminated so as to approximate to a sectional area of the slot in a direction orthogonal to a rotational axis; thus, it is possible to improve an area ratio of a sectional area occupied by the coil to the sectional area of the slot (hereinafter, referred to as a space factor). With regard to a structure of such stator of a rotating electric machine, there is a technique disclosed in the following patent publication.

For example, Japanese Patent Laying-Open No. 2001-178053 discloses a stator of a rotating electric machine capable of achieving size reduction and improvement in workability by reduction in length of a coil end. The stator of the rotating electric machine has a stator core, teeth of the stator core, and stator coils attached to a plurality of slots each formed between two teeth. Each stator coil has a configuration that two sets of laminated straight sheet conductors are integrally molded into one through an insulating resin. The stator coil includes laminated coil pieces each of which has a configuration that connection ends are formed at both ends of a conductor, and first and second connection coil pieces each of which has a configuration that laminated sheet conductors are integrally molded into one through an insulating resin. First ends of the sheet conductors of the laminated coil pieces inserted into the plurality of slots of the stator core are connected to each other through the sheet conductors of the first connection coil piece with a tooth interposed therebetween. Second ends are connected to each other through the sheet conductors of the second connection coil piece with the tooth interposed therebetween such that the sheet conductors laminated in a radial direction of the stator core are displaced one by one in the radial direction. The stator has a feature in that a stator coil is wound around a tooth as described above.

According to the stator of the rotating electric machine disclosed in this patent publication, it is possible to achieve size reduction and improvement in workability by reduction in length of a coil end.

However, if a space factor is further improved in the stator of the rotating electric machine disclosed in the aforementioned patent publication, there is a problem that sufficient insulating performance cannot be secured. The stator coil disclosed in the aforementioned patent publication is formed as follows: sheet conductors are laminated with a clearance interposed therebetween and, then, are integrally molded into one by filling such clearance with a resin. Therefore, when the clearance is further decreased in order to improve a space factor, there is a possibility that the clearance cannot be filled with a resin having certain viscosity.

In the stator of the rotating electric machine disclosed in the aforementioned patent publication, further, connection terminals are formed in such a manner that ends of a coil are subjected to machining after integral molding. Therefore, if a burr or a chip generated in the machining is interposed between turns of the coil, there is a problem of a short circuit.

### DISCLOSURE OF THE INVENTION

An object of the present invention is to provide a stator of a rotating electric machine capable of improving a space factor and achieving insulation in a coil, and a component for use in the stator.

A component for use in a stator according to one aspect of the present invention includes a coil plate having an insulating member attached to at least one side thereof and an “I”-shaped portion to be inserted into a slot of a stator core. The plurality of coil plates forming coils of an identical phase are laminated in a thickness direction of the “I”-shaped portions. The coil plates opposite to each other are formed such that a shortest distance between end faces of the “I”-shaped portions in a width direction is longer than a shortest distance between end faces of the “I”-shaped portions in the thickness direction.

According to the present invention, in laminated coil plates opposite to each other, a shortest distance between end faces of “I”-shaped portions in a width direction is longer than a shortest distance between end faces of the “I”-shaped portions in a thickness direction. Moreover, insulating members are attached to the end faces of the laminated coil plates in the thickness direction. Therefore, such insulating member secures insulation between the end faces in the thickness direction. On the other hand, no insulating member is attached to each of the end faces of the laminated coil plates in the width direction. Therefore, the insulating member secures the insulation between the end faces in the thickness direction; however, if a distance between the end faces becomes short in order to improve a space factor, there is a possibility that electric discharge occurs due to the short distance between the end faces in the width direction when electric power is supplied to a coil. In order to avoid this disadvantage, the coil plates are formed such that the shortest distance between the end faces in the width direction is longer than the shortest distance between the end faces in the thickness direction (for example, a chamfered shape is formed in a longitudinal direction), so that the distance between the end faces in the width direction (shortest distance and creepage distance) is extended. As a result, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property. Accordingly, it is possible to provide a component for use in a stator capable of improving a space factor and achieving insulation in a coil.

Preferably, the “I”-shaped portion of the coil plate is formed into a chamfered shape in a longitudinal direction.

According to the present invention, an “I”-shaped portion of a coil plate is formed into a chamfered shape in a longitudinal direction. Therefore, in coil plates opposite to each other, even when a shortest distance between end faces in a thickness direction is made short in order to improve a space factor, a shortest distance between end faces in a width direction becomes longer than the shortest distance in the thickness direction because of the chamfered shape. That is, a creepage distance between the end faces in the width direction is extended by the chamfered shape. Therefore, when at least the creepage distance is made longer than an electric discharge start distance, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property.

More preferably, the “I”-shaped portion of the coil plate is formed into a step shape in a longitudinal direction.

According to the present invention, an “I”-shaped portion of a coil plate is formed into a step shape in a longitudinal direction. Therefore, in coil plates opposite to each other, even when a shortest distance between end faces in a thickness direction is made short in order to improve a space factor, a shortest distance between end faces in a width direction becomes longer than the shortest distance in the thickness direction because of the step shape. That is, a creepage distance between the end faces in the width direction is extended by the step shape. Therefore, when at least the creepage distance is made longer than an electric discharge start distance, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property. Moreover, the formation of the step shape facilitates press working. Therefore, it is possible to suppress an increase in cost.

More preferably, the coil plate is a coil plate formed into an “I”-shape. The component further includes an insulated retaining member for integrally retaining the laminated coil plates forming the coils of the identical phase. The insulated retaining member retains laminated coil plates of different phases to be inserted into the identical slot.

According to the present invention, an insulated retaining member integrally retains laminated coil plates forming coils of an identical phase. Further, the insulated retaining member retains laminated coil plates of different phases inserted into an identical slot. With this configuration, it is possible to verify an interphase insulation state of the plurality of coil plates retained by the insulated retaining member prior to an operation for mounting the insulated retaining member to a slot of a stator core. Therefore, it becomes unnecessary to conduct a verification after the operation for mounting the insulated retaining member to the slot. Thus, it is possible to suppress generation of defectives about insulation on a stator basis. Accordingly, it is possible to suppress an increase in cost.

More preferably, the coil plate has an end provided with a step-shaped joining face so as to decrease a thickness thereof. A corner of the coil plate, which comes into contact with an end face of the opposing coil plate in the width direction, is formed smoothly.

According to the present invention, a corner of a coil plate, which comes into contact with an end face of an opposing coil plate in a width direction, is formed smoothly. For example, in a case that an end of a coil plate is joined to a coil end plate (transition member) while being applied with a pressure in a thickness direction of the coil plate, a distance between the end of the coil plate and an end of an adjoining coil plate becomes short by application of the pressure and the adjoining coil plate is warped. Even when the adjoining coil plate is warped, the corner of the coil plate, which is formed smoothly, suppresses concentration of a force on the warped coil plate. Therefore, it is possible to prevent an insulating member attached to the coil plate from being dropped or peeled off.

More preferably, the coil plate has an end provided with a step-shaped joining face so as to decrease a thickness thereof. The coil plate has a tapered shape so as to gradually decrease a thickness of the joining face toward the end.

According to the present invention, a step-shaped end of a coil plate is formed into a tapered shape so as to gradually decrease a thickness of a joining face toward the end. With this configuration, in a case that a connection member is inserted into the end of the coil plate in a longitudinal direction of an “I”-shaped portion, the joining face is not parallel with the inserting direction of the connection member. Therefore, there is no possibility that the joining faces of the coil plate and the connection member slide each other. Since sliding of the joining faces is suppressed, a joining material to be applied to one of the joining faces of the coil plate and the connection member can be prevented from being dropped or peeled off.

A stator of a rotating electric machine according to another aspect of the present invention is a stator of a rotating electric machine including a rotor and such stator. This stator includes: a stator core having a plurality of slots formed in parallel with a rotational axis of the rotating electric machine; and a coil plate laminate having a configuration that a plurality of coil plates each having an insulating member attached to at least one side thereof are laminated in a radial direction. The coil plate has an “I”-shaped portion to be inserted into the slot. The coil plates opposite to each other are formed such that a shortest distance between end faces of the “I”-shaped portions in a width direction is longer than a shortest distance between end faces of the “I”-shaped portions in the thickness direction.

According to the present invention, in a coil plate laminate, coil plates opposite to each other are formed such that a shortest distance between end faces of “I”-shaped portions in a width direction is longer than a shortest distance between end faces of the “I”-shaped portions in a thickness direction. Moreover, insulating members are attached to the end faces of the laminated coil plates in the thickness direction. Therefore, such insulating member secures insulation between the end faces in the thickness direction. On the other hand, no insulating member is attached to each of the end faces of the laminated coil plates in the width direction. Therefore, the insulating member secures the insulation between the end faces in the thickness direction; however, if a distance between the end faces becomes short in order to improve a space factor, there is a possibility that electric discharge occurs due to the short distance between the end faces in the width direction when electric power is supplied to a coil. In order to avoid this disadvantage, the coil plates are formed such that the shortest distance between the end faces in the width direction is longer than the shortest distance between the end faces in the thickness direction (for example, a chamfered shape is formed in a longitudinal direction), so that the distance between the end faces in the width direction (shortest distance and creepage distance) is extended. As a result, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property. Accordingly, it is possible to provide a stator of a rotating electric machine capable of improving a space factor and achieving insulation in a coil.

Preferably, the “I”-shaped portion of the coil plate is formed into a chamfered shape in a longitudinal direction.

According to the present invention, an “I”-shaped portion of a coil plate is formed into a chamfered shape in a longitudinal direction. Therefore, in coil plates opposite to each other, even when a shortest distance between end faces in a thickness direction is made short in order to improve a space factor, a shortest distance between end faces in a width direction becomes longer than the shortest distance in the thickness direction because of the chamfered shape. That is, a creepage distance between the end faces in the width direction is extended by the chamfered shape. Therefore, when at least the creepage distance is made longer than an electric discharge start distance, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property.

More preferably, the “I”-shaped portion of the coil plate is formed into a step shape in a longitudinal direction.

According to the present invention, an “I”-shaped portion of a coil plate is formed into a step shape in a longitudinal direction. Therefore, in coil plates opposite to each other, even when a shortest distance between end faces in a thickness direction is made short in order to improve a space factor, a shortest distance between end faces in a width direction becomes longer than the shortest distance in the thickness direction because of the step shape. That is, a creepage distance between the end faces in the width direction is extended by the step shape. Therefore, when at least the creepage distance is made longer than an electric discharge start distance, an insulating property can be secured. Further, even when a burr generated in copper plate machining is attached to a coil plate or an insulating member or a thickness of an insulating member varies due to a joining operation, the extended distance is secured. Therefore, it is possible to prevent occurrence of a short circuit and to suppress deterioration in insulating property. Moreover, the formation of the step shape facilitates press working. Therefore, it is possible to suppress an increase in cost.

More preferably, the coil plate is a coil plate formed into an “I” shape. The coil plate laminate further includes an insulated retaining member for integrally retaining the laminated coil plates forming the coils of the identical phase. The insulated retaining member retains laminated coil plates of different phases to be inserted into the identical slot.

According to the present invention, an insulated retaining member integrally retains laminated coil plates forming coils of an identical phase. Further, the insulated retaining member retains laminated coil plates of different phases inserted into an identical slot. With this configuration, it is possible to verify an interphase insulation state of the plurality of coil plates retained by the insulated retaining member prior to an operation for mounting the insulated retaining member to a slot of a stator core. Therefore, it becomes unnecessary to conduct a verification after the operation for mounting the insulated retaining member to the slot. Thus, it is possible to suppress generation of defectives about insulation on a stator basis. Accordingly, it is possible to suppress an increase in cost.

More preferably, the coil plate has an end provided with a step-shaped joining face so as to decrease a thickness thereof. A corner of the coil plate, which comes into contact with an end face of the opposing coil plate in the width direction, is formed smoothly.

According to the present invention, a corner of a coil plate, which comes into contact with an end face of an opposing coil plate in a width direction, is formed smoothly. For example, in a case that an end of a coil plate is joined to a coil end plate (transition member) while being applied with a pressure in a thickness direction of the coil plate, a distance between the end of the coil plate and an end of an adjoining coil plate becomes short by application of the pressure and the adjoining coil plate is warped. Even when the adjoining coil plate is warped, the corner of the coil plate, which is formed smoothly, suppresses concentration of a force on the warped coil plate. Therefore, it is possible to prevent an insulating member attached to the coil plate from being dropped or peeled off.

More preferably, the coil plate has an end provided with a step-shaped joining face so as to decrease a thickness thereof. The coil plate has a tapered shape so as to gradually decrease a thickness of the joining face toward the end.

According to the present invention, a step-shaped end of a coil plate is formed into a tapered shape so as to gradually decrease a thickness of a joining face toward the end. A connection member for connecting between coil plates inserted into adjoining slots (for example, coil end plate) is mounted to the end of the coil plate. Accordingly, in a case that a connection member is inserted into the end of the coil plate in a longitudinal direction of “I”-shaped portion, the joining face is not parallel with the inserting direction of the connection member. Therefore, there is no possibility that the joining faces of the coil plate and the connection member slide each other. Since sliding of the joining faces is suppressed, a joining material to be applied to one of the joining faces of the coil plate and the connection member can be prevented from being dropped or peeled off.

More preferably, the stator further includes a connection member for connecting between coil plate laminates inserted into different slots, respectively. The coil plate is joined to the connection member through a paste-like joining material containing metal nanoparticles each coated with an organic substance and an organic solvent.

According to the present invention, an end of a coil plate is joined to a connection member (for example, transition member and bus bar) through a paste-like joining material containing metal nanoparticles each coated with an organic substance and an organic solvent. In the joining material, when the organic substance serving as a protection layer is decomposed by application of heat, sintering of the metal nanoparticles is commenced at a low temperature. Therefore, the sintering temperature can be made lower than a melting temperature of an insulating material. On the other hand, the sintered metal nanoparticles are in a metal bonded state, and are not melted until a time when the temperature is increased to an eutectic temperature of the metal with the material for the coil plate (for example, about 1000° C. in case of using silver and copper). Using such joining material, the temperature in the joining operation is lower than the melting temperature of the insulating material, so that deterioration in insulating performance of the insulating member can be suppressed. After the joining operation, further, the melting temperature at the joint is sufficiently higher than heat generated upon actuation of a rotating electric machine, so that deterioration in joining strength can be suppressed.

More preferably, the connection member has ends in a longitudinal direction each provided with a flat face coming into contact with the joining face formed on the coil plate when the connection member is mounted to the coil plate while being moved in a predetermined direction with respect to the coil plate.

According to the present invention, in a case that a connection member is mounted to a coil plate, a joining face of the coil plate comes into contact with that of the connection member without being slid. Therefore, a joining material applied to one of the joining faces of the coil plate and the connection member can be prevented from being dropped or peeled off.

More preferably, the connection member is a coil end plate for connecting between coil plate laminates inserted into adjoining slots, respectively. The coil end plate has an end face opposite to a portion coming into contact with the joining face of the coil plate, and the end face is formed into a chamfered shape in the longitudinal direction.

According to the present invention, a coil end plate is also formed into a chamfered shape in a longitudinal direction, so that a creepage distance between coil end plates can be extended. Further, a creepage distance between a coil end plate and a coil plate can be extended. Accordingly, when the creepage distance between the coil end plates and the coil end plate and the coil plate is made longer than an electric discharge start distance, an insulating property can be secured. Further, even when a burr generated in copper plate machining is interposed between the coil end plates or is interposed between the coil end plate and the coil plate, the extended distance by the chamfered shape is secured. Therefore, it is possible to prevent occurrence of a short circuit and to suppress deterioration in insulating property.

More preferably, the joining material is applied to the connection member.

According to the present invention, a joining material is applied to a connection member. Therefore, it is possible to avoid connection failure due to dropping or peeling of the joining material until a time when the connection member is mounted to a coil plate. Thus, it is possible to improve reliability about insulation.

### BRIEF DESCRIPTION OF THE DRAWINGS

FIG. 1 is a perspective view of a stator according to an embodiment of the present invention.

FIG. 2 is a flowchart showing a procedure of a method for manufacturing the stator according to this embodiment.

FIG. 3 is a perspective view of a coil plate.

FIG. 4 is a view showing a mounting process for a coil plate laminate.

FIG. 5 is a perspective view of a coil sub-assy.

FIG. 6 is an external view of the coil sub-assy when being seen in a direction of an arrow A in FIG. 5.

FIG. 7 is a view showing a process of mounting a coil sub-assy to a stator core.

FIG. 8 is a perspective view of a coil sub-assy mounted to a stator core.

FIG. 9 is a view showing a process of mounting a transition member laminate to a coil sub-assy.

FIGS. 10A and 10B are perspective views of transition members.

FIGS. 11A and 11B are views each schematically showing a joint between a coil plate and a transition member.

FIG. 12 is a view showing the joint between the coil plate and the transition member when being seen in a direction of an arrow B in FIG. 11A.

FIG. 13 is a view showing a process of mounting a bus bar to a coil sub-assy.

FIG. 14 is a view showing a process of mounting a terminal member to a coil sub-assy.

FIG. 15 is a perspective view of a stator prior to joining.

FIG. 16 is a view showing a direction of applying a pressure to a coil sub-assy.

FIG. 17 is a perspective view of a stator subjected to a resin molding process.

FIG. 18 is a view showing a section of a stator core to which a coil sub-assy is mounted.

FIGS. 19A and 19B are enlarged views of a portion surrounded with a solid circle in FIG. 18.

FIGS. 20A and 20B are enlarged views of a portion surrounded with a solid circle in FIG. 19A.

FIG. 21 is a view showing a section taken along a line 21-21 in FIG. 18.

FIG. 22 is a view (example 1) showing a joint between a coil plate and a transition member.

FIG. 23 is a view (example 2) showing a joint between a coil plate and a transition member.

FIG. 24 is a view (example 3) showing a joint between a coil plate and a transition member.

FIG. 25 is a perspective view of a stator core to which a transition member is mounted.

FIG. 26 is a perspective view of the stator core when being seen in a direction of an arrow C in FIG. 25.

FIGS. 27A and 27B are views (example 4) each showing a joint between a coil plate and a transition member.

### BEST MODES FOR CARRYING OUT THE INVENTION

With reference to the drawings, hereinafter, description will be given of an embodiment of the present invention. In the following description, identical components are denoted by identical symbols and are provided with identical designations and functions; therefore detailed description thereof will not be given repeatedly.

A stator according to this embodiment is a stator of a rotating electric machine configured by such stator and a rotor formed of a permanent magnet. In this embodiment, the stator is a stator of a three-phase alternating synchronous rotating electric machine having 21 poles. However, the present invention should be applied to a stator around which a coil is wound, and the number of poles is not particularly limited to 21. Further, the present invention is not limitedly applied to a stator of a three-phase alternating synchronous rotating electric machine.

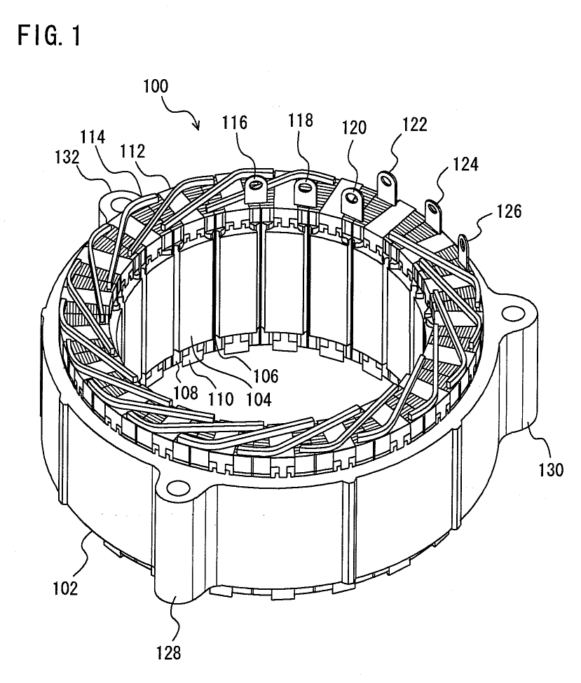

As shown in FIG. 1, a stator 100 includes a stator core 102, coil sub-assys 108, laminates 110 and 112 of transition members (also referred to as coil end plates in the following description), and bus bars 114.

Stator core 102 is formed into a hollow cylindrical shape. Slots 106 are formed by a predetermined number in a circumferential direction of stator core 102 so as to penetrate through stator core 102 in a direction parallel with a rotational axis. Further, teeth 104 are formed by the predetermined number between slots 106 of stator core 102, respectively, so as to be opposite to an axial center of the rotational axis. The predetermined number corresponds to the number of poles. In this embodiment, the number of slots 106 and that of teeth 104 are 21, respectively. Also in this embodiment, stator core 102 is formed in such a manner that a plurality of electromagnetic steel plates are laminated.

Coil sub-assys 108 are inserted into slots 106 formed in stator core 102. Each coil sub-assy 108 has a configuration that two sets of coil plate laminates (not shown) are integrally retained by a resin insulator (not shown). Each coil plate laminate has a configuration that a plurality of “I”-shaped coil plates are laminated in a radial direction. Herein, the coil plate laminate may be configured as follows. That is, a plurality of “I”-shaped coil plates are laminated such that a width direction of each coil plate is orthogonal to a wall face of a tooth in a slot. In this embodiment, a coil plate is formed into an “I” shape. However, such shape is not particularly limited as long as a portion to be inserted into a slot 106 is formed into an “I” shape. For example, such coil plate may be formed into a “U” shape.

Protrusions 128, 130 and 132 each protruding outward in the radial direction are formed on a cylindrical outer peripheral face of stator core 102. Each of protrusions 128, 130 and 132 is provided with a through hole penetrating therethrough in a direction of the rotational axis. Stator core 102 is fastened to a housing of a rotating electric machine with bolts inserted into the through holes.

In two coil sub-assys 108 inserted into slots located at both sides of a tooth 104, coil plate laminates adjoining to an identical tooth are connected to each other through transition member laminates 110 and 112. In FIG. 1, transition member laminate 110 is mounted to tooth 104 at an upward side, and transition member laminate 112 is mounted to tooth 104 at a downward side. Transition member laminates 110 and 112 form coil ends.

Each of transition member laminates 110 and 112 has a configuration that a plurality of transition members are laminated. Transition members connect between ends of coil plates configuring two coil plate laminates located at both sides of a tooth 104 (that is, inserted into different slots).

When transition member laminates 110 and 112 are mounted to two coil plate laminates located at both sides of a tooth 104, a coil is spirally wound around tooth 104 by a predetermined number of turns (14 turns in this embodiment). Herein, coils are wound around respective teeth in an identical direction.

Herein, ends of a coil wound around a tooth 104 by 14 turns correspond to an end of a coil plate which is proximal to the axial center and is connected with no transition members and an end of a coil plate which is distal from the axial center and is connected with no transition members.

These ends are connected with one of ends of a bus bar 114, respectively. The other end of bus bar 114 is connected to ends of a coil of an identical phase wound around another tooth (that is, a coil plate laminate inserted into a different slot). In stator core 102, thus, coils corresponding to a U phase, a V phase and a W phase are wound around teeth by 14 turns, respectively.

Ends of the coils of the respective phases are provided with terminal members 116 to 126. Herein, terminal members 116 and 122 correspond to the ends of the U-phase coil, terminal members 118 and 124 correspond to the ends of the V-phase coil, and terminal members 120 and 126 correspond to the ends of the W-phase coil.

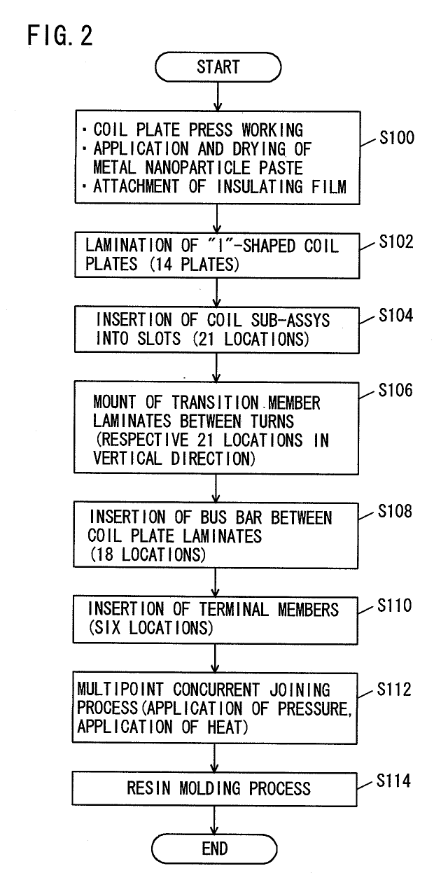

With reference to a flowchart of FIG. 2, hereinafter, detailed description will be given of a procedure of a method for manufacturing stator 100 according to this embodiment.

In step (hereinafter, described as S) 100, an “I”-shaped coil plate is formed by press working.

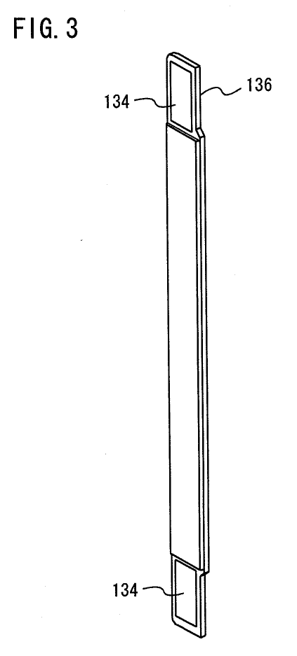

As shown in FIG. 3, a coil plate 136 is formed into an “I” shape in such a manner that a metal flat plate made of a copper rolling material is subjected to press working. For example, coil plate 136 is formed into an “I” shape by shearing. Copper used as a material for coil plate 136 makes it possible to improve a heat radiating property of coil plate 136 because of its high heat conductivity. In addition, copper is low in internal resistance and is high in conductivity as a conductor. Therefore, copper makes it possible to reduce heat generated when a current density is improved.

Both ends of coil plate 136 are provided with steps each having a joining face. In this embodiment, a step having a joining face is formed by, for example, machining. In each joining face of coil plate 136, a joining material is applied to a predetermined application range 134. In this embodiment, the joining material is a paste-like joining material containing metal nanoparticles each coated with an organic substance and an organic solvent (hereinafter, referred to as a metal nanoparticle paste). The metal nanoparticles are nanoparticles of metal selected from, for example, one of gold, silver, copper and platinum. In this embodiment, for example, there is used a paste-like joining material containing silver nanoparticles each coated with an organic substance and an organic solvent (hereinafter, referred to as a silver nanoparticle paste). In the silver nanoparticle paste, when an organic substance serving as a protection layer is decomposed by application of heat, sintering of silver nanoparticles is commenced at a low temperature. Therefore, the sintering temperature is low, for example, about 260° C., which is lower than a melting temperature of an insulating material such as PPS (polyphenylenesulfide). On the other hand, the sintered silver nanoparticles are in a metal bonded state and, therefore, are not melted until a time when the temperature increases to an eutectic temperature of metal silver with copper as a material for a coil plate (about 1000° C.). A joining member containing metal nanoparticles is well known; therefore, detailed description thereof will not be given here.

The silver nanoparticle paste adhered to the joining face is dried so as to be in a tack-free state. Thus, a surface of the silver nanoparticle paste adhered to the joining face is cured, so that a flow of the silver nanoparticle paste is hindered.

Further, an insulating film is attached to at least one side of coil plate 136. In place of the insulating film, a coating film of an insulating coat may be attached to coil plate 136. A material for the insulating film is not particularly limited as long as a thickness thereof can secure insulation between coil plates. The insulating film is, for example, a polyimide film. Such insulating film is attached to at least one of opposing two faces of coil plates 136 in a thickness direction. In this embodiment, an insulating film is attached to a coil plate 136 so as to entirely cover a side on which no joining face is formed.

Further, a sectional shape of a coil plate including a thickness and a width changes in accordance with a position of the coil plate upon lamination.

More specifically, in a plurality of laminated coil plates, a coil plate proximal to a back yoke side of stator core 102 has a larger width and a smaller thickness. When a sectional shape of a coil plate is changed in accordance with a position of the coil plate upon lamination, a sectional shape of a coil plate laminate to be inserted into a slot can be set freely. That is, when a sectional area of a coil plate laminate is made approximate to that of a slot, a space factor can be improved.

With reference to FIG. 2 again, in S102, “I”-shaped coil plates are laminated to assemble a coil sub-assy 108.

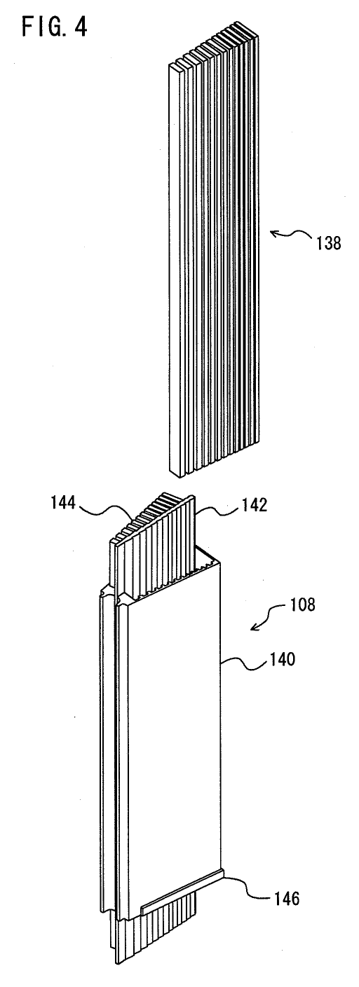

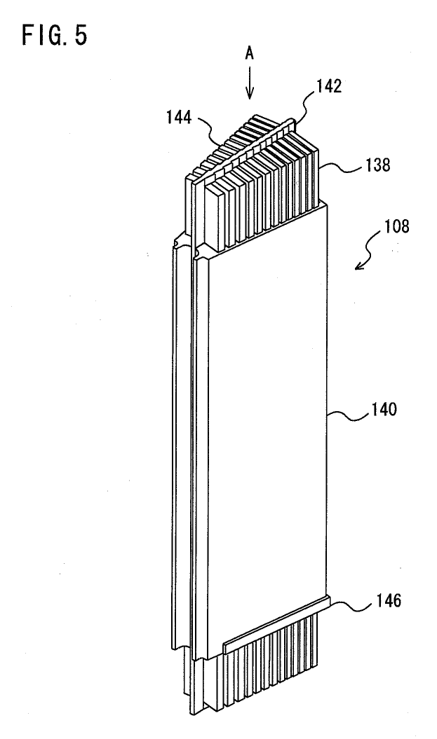

As shown in FIG. 4, coil plate laminates 138 and 144 each configured by a plurality of coil plates are inserted into a resin insulator 140 in a longitudinal direction of resin insulator 140; thus, coil sub-assy 108 shown in FIG. 5 is assembled. In each of coil plate laminates 138 and 144, the coil plates are laminated with an insulating film interposed therebetween.

When the plurality of coil plates are inserted into resin insulator 140, positions thereof are restricted by resin insulator 140. Resin insulator 140 is a hollow insulating member formed so as to come into contact with an inner wall face of a slot. Herein, the shape of resin insulator 140 is not particularly limited to the hollow shape as long as resin insulator 140 at least restricts the positions of coil plate laminates 138 and 144 to integrally retain coil plate laminates 138 and 144.

Examples of a material for resin insulator 140 include epoxy resin, polyphenylenesulfide (PPS), liquid crystal polymer (LCP), polyetheretherketone (PEEK) and the like. Resin insulator 140 is formed into a predetermined shape. The material for resin insulator 140 is not particularly limited to the aforementioned materials as long as resin insulator 140 can be formed by resin molding.

At a center of resin insulator 140, further, an insulating plate 142 is formed so as to separate coil plate laminates 138 and 144 from each other. Insulating plate 142 hinders contact between coil plate laminates of different phases in an identical slot. Insulating plate 142 makes it possible to achieve insulation between coil plate laminates to be inserted into an identical slot (interphase insulation).

Further, at least one of ends of resin insulator 140 in the longitudinal direction is provided with a protrusion 146 formed in an outer peripheral direction of resin insulator 140.

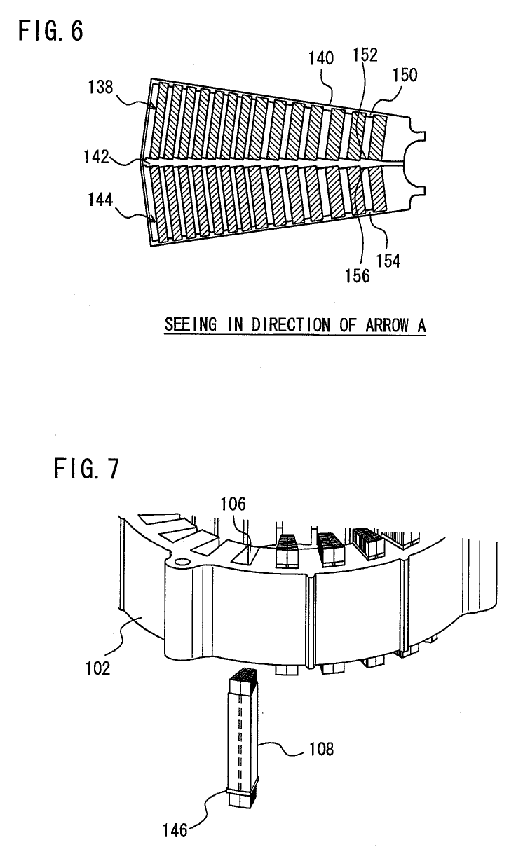

FIG. 6 shows an outer appearance of the coil sub-assy when being seen in a direction of an arrow A in FIG. 5. As shown in FIG. 6, resin insulator 140 has a sectional shape formed into a substantially sector shape such that an outer peripheral face thereof comes into contact with an inner wall face of a slot. Insulating plate 142 divides a space in resin insulator 140 into two so as to divide a center angle of the substantially sector shape into equal halves.

On the inner wall face of resin insulator 140 located at an upward side in FIG. 6, grooves are provided by a plurality of protrusions 150 formed in the longitudinal direction of resin insulator 140. Protrusions 150 are provided at predetermined spacings in the radial direction. A width of a groove formed between two protrusions 150 corresponds to a thickness of a coil plate to be inserted. Accordingly, protrusions 150 are formed so as to gradually increase a width of a groove toward a center of the substantially sector shape in the radial direction. This groove restricts a position of a coil plate (hatched portion) in a thickness direction.

Further, step-shaped protrusions 152 are formed on a surface of insulating plate 142 at a position opposite to the inner wall face located at the upward side in FIG. 6. Each protrusion 152 has a face parallel with a bottom face of a groove. Protrusion 152 is formed in the longitudinal direction of resin insulator 140. Herein, a distance from the bottom face of the groove to the face of protrusion 152 formed on insulating plate 142 corresponds to a width of a coil plate to be inserted. Accordingly, a length from the bottom face of the groove to the face of protrusion 152 becomes gradually short toward the center of the substantially sector shape in the radial direction. The face of protrusion 152 formed on insulating plate 142 restricts a position of a coil plate in a width direction.

In this embodiment, a coil plate laminate 138 is configured by 14 coil plates. Therefore, 14 grooves are formed on resin insulator 140 by protrusions 150. Further, 14 protrusions 152 are formed on insulating plate 142.

Similarly, protrusions 154 and 156 are formed in a space in insulating plate 142 located at a downward side in FIG. 6 to restrict positions of 14 laminated coil plates configuring coil plate 144 in a thickness direction and a width direction. Details thereof will not be described repeatedly.

A plurality of coil plates configuring each of coil plate laminates 138 and 144 are slid and inserted into corresponding grooves in accordance with sectional shapes thereof. The positions of the inserted coil plates are restricted in an inserting direction by inner wall faces of resin insulator 140 and insulating plate 142.

That is, a coil plate laminate 138 inserted into resin insulator 140 is held by a protrusion 150, a groove formed between two protrusions 150, and a protrusion 152 formed on insulating film 142. Therefore, a position of coil plate laminate 138 in an inserting direction is restricted by a frictional force. Herein, the position in the inserting direction may be restricted by formation of an “L”-shaped bent portion or a protrusion on each of ends of coil plates configuring a coil plate laminate. A distance between laminated coil plates is longer than an electric discharge start distance determined from a thickness of an insulating film interposed between coil plates and an interphase voltage.

With reference to FIG. 2 again, in S104, a coil sub-assy 108 is inserted into a slot 106. As shown in FIG. 7, coil sub-assy 108 is inserted into slot 106 of stator core 102 from a downward direction in FIG. 7 with an end, at which a protrusion 146 of resin insulator 140 is formed, directed downward.

When coil sub-assy 108 is inserted into stator core 102, protrusion 146 comes into contact with an end face of stator core 102. Thus, movement of coil sub-assy 108 in an upward direction in FIG. 7 is restricted. Coil sub-assys 108 are inserted into all (21) slots formed in stator core 102, respectively.

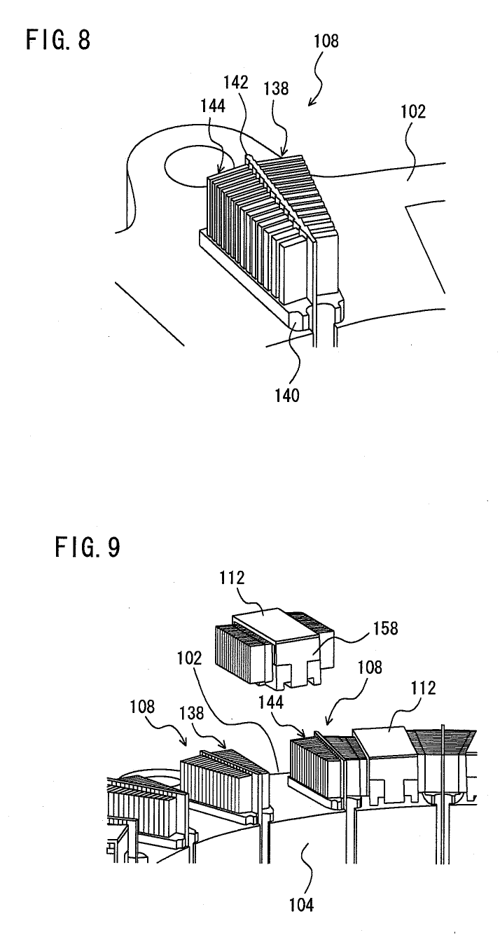

As shown in FIG. 8, when coil sub-assy 108 is inserted into stator core 102, the position of each of coil plate laminates 138 and 144 is restricted in the radial direction, the circumferential direction and the axial direction by resin insulator 140. Further, direct contact of coil plate laminates 138 and 144 with stator core 102 is restricted by resin insulator 140.

With reference to FIG. 2 again, in S106, transition members are inserted for connection between ends of coil plates configuring coil plate laminates 138 and 144.

As shown in FIG. 9, a transition member laminate 112 is mounted to an upper side of a tooth 104 and a transition member laminate 110 is mounted to a bottom side of tooth 104 in order to connect between coil plate laminates 138 and 144 provided at both ends of tooth 104 while being opposite to each other.

At a downward side in FIG. 9, the transition members configuring transition member laminate 110 connect between ends of two coil plates opposite to each other with a tooth 104 interposed therebetween.

At an upward side in FIG. 9, on the other hand, the transition members configuring transition member laminate 112 connect between one of ends of two coil plates opposite to each other with a tooth 104 interposed therebetween and an end of a coil plate adjoining to the other end on a back yoke side.

In the aforementioned positional relation, the transition members connecting between the ends of the respective coil plates bring a state that a coil is spirally wound around a tooth 104 by a predetermined turns (14 turns in this embodiment).

In each of transition member laminates 110 and 112, a plurality of laminated transition members (hereinafter, also referred to as coil end plates) are integrally retained by a retaining member 158 made of an insulating material. Herein, retaining member 158 may be a member for integrally molding centers of a plurality of laminated transition members into one by resin molding, or may be a member for integrally retaining centers of a plurality of laminated transition members by pinching.

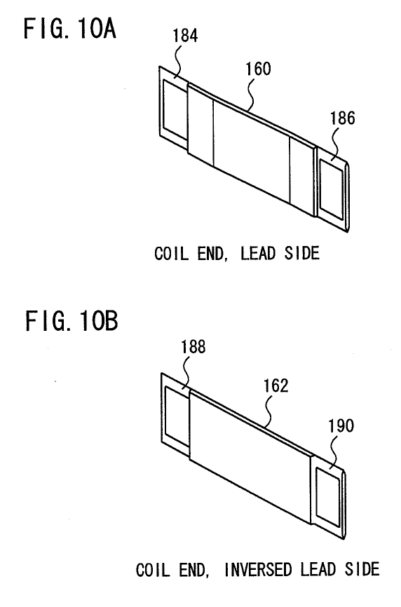

A transition member 160 shown in FIG. 10A is a coil end plate configuring a transition member laminate 112. Transition member 160 is a coil end plate on a side having an end of a coil plate connected to one of ends of a bus bar 114 (lead side).

Both ends of transition member 160 are provided with steps having joining faces 184 and 186, respectively. In each of joining faces 184 and 186 at the both ends of transition member 160, a silver nanoparticle paste is adhered to a predetermined application range. The silver nanoparticle paste is adhered in press working for transition member 160.

On the other hand, a transition member 162 shown in FIG. 10B is a coil end plate configuring a transition member laminate 110. Transition member 162 is a coil end plate on a side having no end of a coil plate connected to bus bar 114 (inversed lead side).

Both ends of transition member 162 are provided with steps having joining faces 188 and 190, respectively. In each of joining faces 188 and 190 at the both ends of transition member 162, a silver nanoparticle paste is adhered to a predetermined application range. The silver nanoparticle paste is adhered in press working for transition member 162.

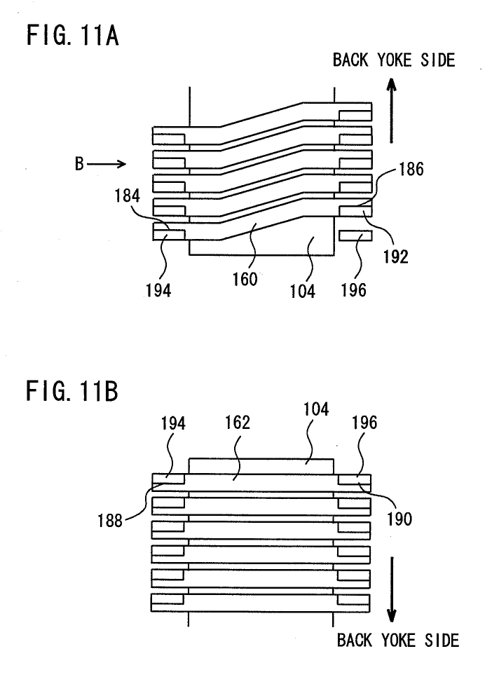

As shown in FIG. 11A which schematically shows a joint between a coil plate and a transition member, joining faces 184 and 186 provided at both ends of a transition member 160 have a positional relation that one of the joining faces is displaced in parallel by a predetermined distance from an identical plane of the other joining face. Accordingly, transition member 160 joins an end of a coil plate 194 to an end of a coil plate 192 adjoining to a back yoke side of a coil plate 196 opposite to coil plate 194 with a tooth 104 interposed therebetween.

Laminated coil end plates are different in thickness from each other depending on a radial position in a slot. Therefore, a distance between joining faces 184 and 186 provided at the both ends of transition member 160 varies depending on a thickness of a coil plate to be connected thereto.

Transition member laminate 112 has a configuration that 13 transition members 160 are laminated. Herein, 13 transition members 160 are integrally retained by a retaining member 158 while being positioned so as to come into contact with ends of corresponding coil plates, respectively.

On the other hand, as shown in FIG. 11B, joining faces 188 and 190 provided at both ends of a transition member 162 are flush with each other. Accordingly, transition member 162 connects between ends of two coil plates 194 and 196 opposite to each other with a tooth 104 interposed therebetween.

Transition member laminate 110 has a configuration that 14 transition members 162 are laminated. Herein, 14 transition members 162 are integrally retained by a retaining member while being positioned so as to come into contact with ends of two coil plates opposite to each other with tooth 104 interposed therebetween.

When 21 transition member laminates 110 and 21 transition member laminates 112 are mounted to stator core 102, predetermined joining faces of coil plates of coil plate laminates 138 and 144 come into contact with joining faces provided at both ends of a transition member in a predetermined positional relation. In this embodiment, the joining face provided at the end of the coil plate is directed outward in the radial direction and the joining face of the transition member is directed inward in the radial direction with respect to stator core 102.

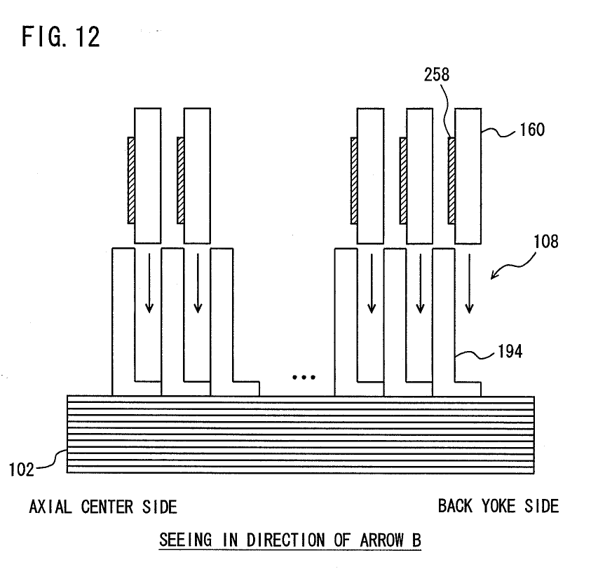

FIG. 12 shows the joint between the coil plate and the transition member when being seen in a direction of an arrow B in FIG. 11A. As shown in FIG. 12, transition member laminate 112 is mounted to the end of coil sub-assy 108 mounted to stator core 102. In this embodiment, the silver nanoparticle paste is applied to each of the coil plate and the transition member. Preferably, as shown in FIG. 12, a silver nanoparticle paste 258 is applied to transition member 160. Thus, the silver nanoparticle paste is not adhered to coil plate 194 until a time when transition member 160 is mounted to coil sub-assy 108. That is, in a step of assembling coil sub-assy 108 and a step of mounting coil sub-assy 108 to stator core 102, it is possible to suppress problems such as adhesion of foreign matters to a silver nanoparticle paste, and dropping or peeling of the silver nanoparticle paste. As a result, junction failure between joining faces is suppressed; thus, it is possible to suppress deterioration in performance of a rotating electric machine due to such junction failure.

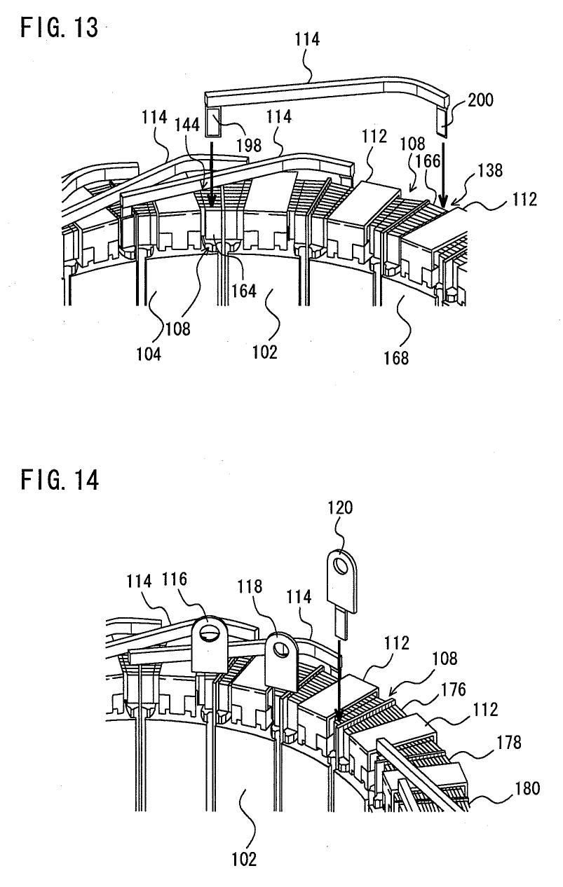

With reference to FIG. 2 again, in S108, a bus bar 114 is inserted into an end of a coil plate. As shown in FIG. 13, transition member laminates 110 and 112 are mounted to all coil sub-assys 108 (21 locations at the upper side and 21 locations at the lower side), and then bus bars 114 are mounted to coil sub-assys 108.

More specifically, a bus bar 114 is formed into a rod shape. “L”-shaped protrusions having joining faces 198 and 200, respectively, are formed at both ends of bus bar 114. Bus bar 114 is bent into a predetermined shape such that joining faces 198 and 200 come into contact with joining faces provided at ends of coil plates of coil plate laminates 138 and 144, respectively.

Herein, 18 bus bars 114 connect coils to each other, and the coils are wound around teeth every three teeth. One of ends of bus bar 114 comes into contact with an end 164 of a coil plate proximal to the axial center from among coil plates configuring a coil wound around a tooth 104. That is, one of ends of bus bar 114 comes into contact with an end 164 of a coil plate proximal to the axial center of a coil plate laminate 144. A coil end 166 corresponds to an end to which no transition member 160 is connected.

The other end of bus bar 114 comes into contact with end 166 of the coil plate distal from the axial center in a coil wound around a tooth 168 spaced away from tooth 104 by three teeth. That is, the other end of bus bar 114 comes into contact with end 166 of the coil plate distal from the axial center in coil plate laminate 138. End 166 corresponds to an end to which no transition member 160 is connected.

With reference to FIG. 2 again, in S110, terminal members 116 to 126 are mounted to coil ends. As shown in FIG. 14, terminal members 116, 118 and 120 are mounted to ends 170, 172 and 174 of coil plates, to which neither bus bars 114 nor transition members 160 are connected, proximal to the axial center in coil sub-assys 108 inserted into stator core 102. Herein, joining faces of ends 170, 172 and 174 of the coil plates proximal to the axial center are directed outward in the radial direction. Therefore, joining faces of terminal members 116, 118 and 120 are inserted between ends 170, 172 and 174 and coil ends adjoining thereto in the radial direction, respectively.

In addition, terminal members 122, 124 and 126 are mounted to ends 176, 178 and 180 of coil plates, to which neither bus bars 114 nor transition members 160 are connected, distal from the axial center. Joining faces of ends of the coil plates distal from the axial center are directed outward in the radial direction. Therefore, terminal members 122, 124 and 126 are positioned by temporary joint or the like.

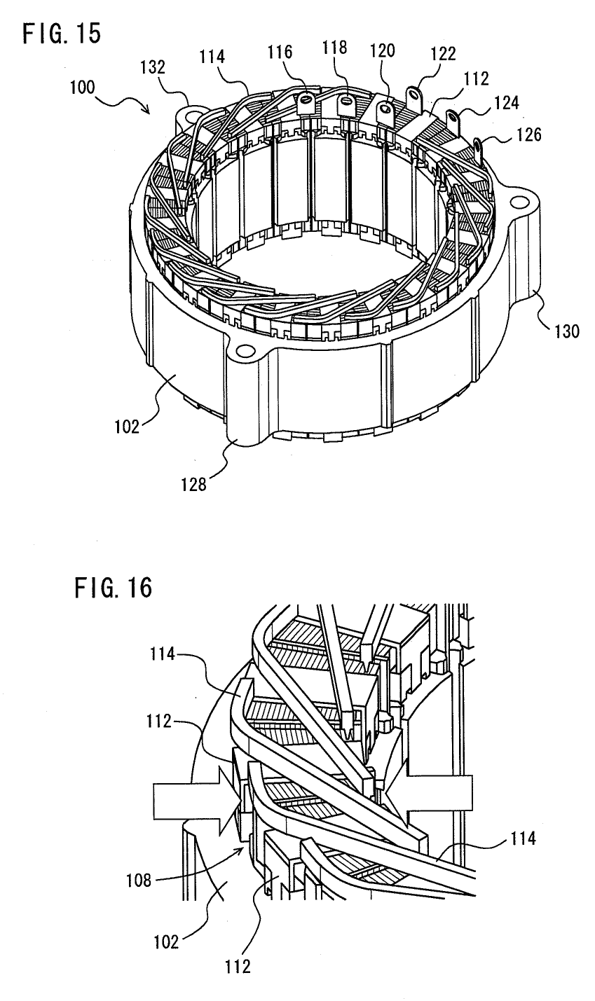

As described above, coil sub-assys 108 are mounted to slots 106 of stator core 102, transition member laminates 110 and 112 are mounted between coil sub-assys 108, and bus bars 114 and terminal members 116 to 126 are mounted respectively. Thus, a stator 100 prior to joining is assembled as shown in FIG. 15.

With reference to FIG. 2 again, in S112, a multipoint concurrent joining process is carried out. Specifically, assembled stator 100 is subjected to a process of joining between the joining faces coming into contact with each other. As shown in FIG. 16, the multipoint concurrent joining process is carried out in such a manner that a temperature is increased while a pressure is applied to the coil ends of the coil plate laminates, to which bus bars 114 or terminal members 116 to 126 and transition member laminates 110 and 112 are mounted, in the radial direction (directions shown by arrows in FIG. 16).

When the temperature is increased, a protection layer for covering silver nanoparticles contained in the silver nanoparticle paste is decomposed, so that the silver nanoparticles are sintered. In addition, when the pressure is applied, gas and the like in the paste, which are generated when the protection layer is decomposed, are eliminated from the joint. The joint is achieved by metal bonding in such a manner that the silver nanoparticle paste is sintered. After the joining process, therefore, the joint is not melted until a time when the temperature is increased to about 1000° C. which is a melting point of metal silver. The protection layer for covering the metal nanoparticles is decomposed at about 260° C. Therefore, the metal nanoparticles are sintered at a low temperature after the protection layer is decomposed at about 260° C. Accordingly, the temperature is increased to a predetermined temperature, about 260° C., lower than a temperature at which the insulating film or resin insulator 140 attached to the coil plate is melted. Therefore, there is no possibility that the insulating film and resin insulator 140 are melted.

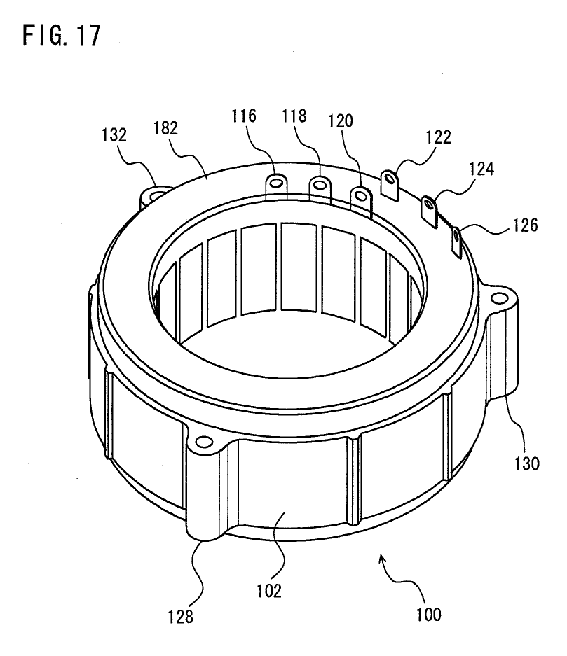

With reference to FIG. 2 again, in S114, a resin molding process is carried out. As shown in FIG. 17, coil ends of stator 100 in which the joining of the joining faces is completed, are subjected to a molding process by injection molding using a resin or the like. Herein, portions other than an outer peripheral face of stator core 102 and terminal members 116 to 126 are coated with a resin 182.

In a rotating electric machine including stator 100 completed as described above and a rotor (not shown), when alternating power is supplied to each of terminal members 116 to 126, a magnetic field is generated in accordance with the supplied power. The rotor obtains a rotating force on the basis of the generated magnetic field to thereby rotate.

In stator 100 having the aforementioned configuration, the present invention has a feature in that coil plates opposite to each other are formed such that a shortest distance between end faces of “I”-shaped portions in a width direction is longer than a shortest distance between end faces of the “I”-shaped portion in a thickness direction in coil plate laminates of an identical phase.

In this embodiment, specifically, an “I”-shaped portion of a coil plate is chamfered in a longitudinal direction of the coil plate at a corner thereof on a back yoke side. The corner of the “I”-shaped portion is not particularly limited to such chamfered shape as long as coil plates opposite to each other are formed such that a shortest distance between end faces of “I”-shaped portions in a width direction is longer than a shortest distance between end faces of the “I”-shaped portion in a thickness direction. For example, the corner of the “I”-shaped portion may be formed into a step shape in the longitudinal direction. This shape facilitates press working, so that it is possible to suppress an increase in cost.

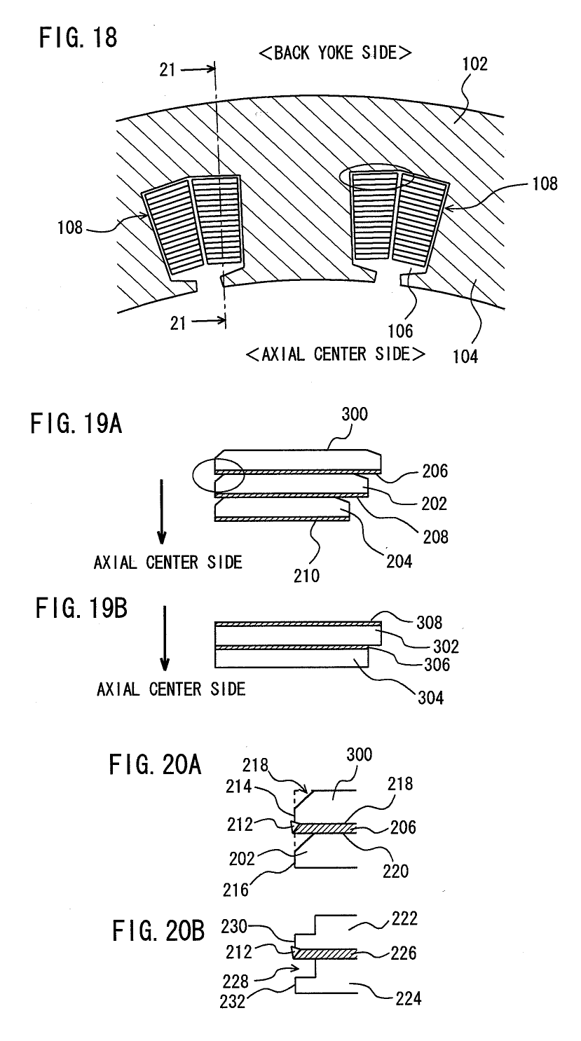

FIG. 18 is a sectional view of stator core 102 to which coil sub-assys 108 are mounted. Herein, a resin insulator 140 is not shown in FIG. 18. As shown in FIG. 18, each of laminated coil plates is chamfered at a corner thereof on a back yoke side. Each coil plate is chamfered in a longitudinal direction (forward to rearward in FIG. 18) thereof.

FIG. 19A is an enlarged view of a portion surrounded with a solid circle in FIG. 18. As shown in FIG. 19A, insulating films 206, 208 and 210 are attached to one of faces of coil plates 300, 202 and 204. Each of coil plates 300, 202 and 204 is chamfered at a corner thereof on a back yoke side.

Preferably, as shown in FIG. 19A, insulating films 206, 208 and 210 are attached to faces of coil plates 300, 202 and 204 on the axial center side. In each of coil plates 300, 202 and 204, a dimension in a width direction becomes gradually large toward the back yoke side.

As shown in FIG. 19B, in a case that insulating films 206, 208 and 210 are attached to the faces on the back yoke side, for example, an insulating film 306 interposed between a coil plate 302 having a long dimension in the width direction and a coil plate 304 having a short dimension in the width direction has a length equal to that of coil plate 304. As a result, there is a portion in which insulating film 306 is not interposed between coil plates 302 and 304. Consequently, there is a high possibility that electric discharge occurs as indicated by a path shown with a broken line in FIG. 19B.

In contrast, as shown in FIG. 19A, insulating films 206, 208 and 210 are attached to the faces on the axial center side, so that insulating film 206 attached to coil plate 300 having a long dimension in the width direction is interposed between coil plate 300 and coil plate 202 having a short dimension in the width direction. Therefore, there is no possibility that the electric discharge occurs as indicated by the path shown with the broken line in FIG. 19B. As a result, deterioration in insulating property can be prevented.

Further, FIG. 20A is an enlarged view of a portion surrounded with a solid circle in FIG. 19A. As shown in FIG. 20A, insulating film 206 attached to coil plate 300 is interposed between coil plate 300 and coil plate 202. Insulating film 206 is interposed between end faces 218 and 220 of coil plates 300 and 202 in the thickness direction, so that occurrence of electric discharge between coil plates 300 and 202 is suppressed. On the other hand, as shown with a broken line in FIG. 20A, in a case that insulating film 206 is not chamfered at a corner thereof in the width direction (lateral direction in FIG. 20A), a creepage distance including the end of insulating film 206 interposed between end faces 214 and 216 of coil plates 300 and 202 in the width direction is equal to a distance between end faces 218 and 220 in the thickness direction.

The distance between end faces 218 and 220 of coil plates 300 and 202, opposite to each other, in the thickness direction is a distance by which occurrence of electric discharge is suppressed based on the premise that insulating film 206 is interposed between coil plates 300 and 202. As a result, there is a possibility that electric discharge may occur even by the distance between end faces 214 and 216 of coil plates 300 and 202 in the width direction. Consequently, there is a possibility that an insulating property is deteriorated.

In this embodiment, as shown with the solid line in FIG. 20A, coil plate 202 is chamfered at the corner thereof on the back yoke side, so that the shortest distance between end faces 214 and 216 of coil plates 300 and 202 in the width direction is extended. Thus, a creepage distance between coil plates 300 and 202 is extended. When coil plate 202 is chamfered such that a creepage distance is set at a distance by which occurrence of electric discharge is suppressed, occurrence of electric discharge between coil plates 300 and 202 is suppressed. Thus, deterioration in insulating property is suppressed.

As shown in FIG. 20A, even when a burr 212 generated in a step of processing coil plate 300 is attached to coil plate 300 or insulating film 206, a distance between burr 212 and coil plate 202 is extended by formation of such chamfered shape. Accordingly, deterioration in insulating property due to attachment of burr 212 can be suppressed. Herein, the size of the chamfered shape is not particularly limited as long as the chamfered shape is formed such that a creepage distance between coil plates 300 and 202 can secure an insulating property.

In this embodiment, in place of the chamfered shape formed in the longitudinal direction of coil plates 300 and 202 as shown in FIG. 20A, a step-shaped portion 228 may be formed in the longitudinal direction of coil plates 222 and 224 as shown in FIG. 20B.

With this configuration, the shortest distance and the creepage distance between end faces 230 and 232 of coil plates 222 and 224 are extended, so that occurrence of electric discharge is prevented. Further, even when burr 212 is attached to insulating film 226, the distance from burr 212 to coil plate 224 is extended, so that occurrence of electric discharge between coil plates 222 and 224 is suppressed. Accordingly, deterioration in insulating property can be suppressed.

The ends of the coil plates in the longitudinal direction are provided with step-shaped joining faces so as to decrease a thickness. This embodiment has a feature in that corner portions coming into contact with end faces of coil plates, opposite to each other, in a width direction are formed smoothly.

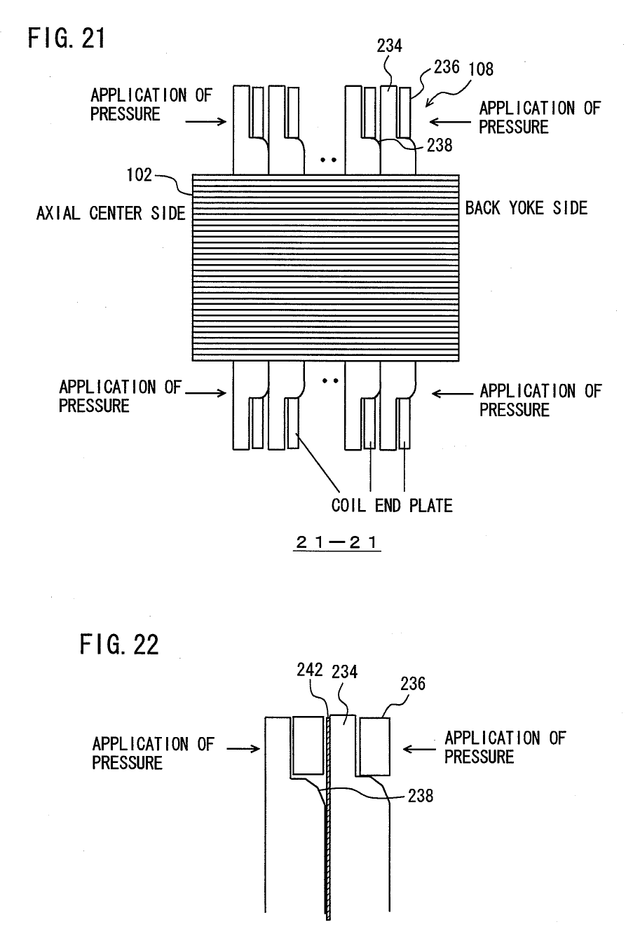

FIG. 21 shows a section taken along a line 21-21 in FIG. 18. An end of a coil sub-assy 108 to which a coil end plate 236 is mounted is joined to coil end plate 236 while being applied with a pressure from both sides in the radial direction (lateral direction in FIG. 21). As shown in FIG. 21, when a pressure is applied to the end of coil sub-assy 108, coil plate 234 is deformed such that a clearance between coil plate 234 and coil end plate 236 is decreased.

Herein, coil plate 234 is deformed so as to protrude toward the back yoke side. Coil plate 234 deformed so as to protrude toward the back yoke side comes into contact with a corner 238 of coil plate 240 adjoining thereto. Corner 238 comes into contact with coil plate 234 in the width direction. If corner 238 has an acute angle, the end face of deformed coil plate 234 comes into contact with the acute angle portion of corner 238, so that the insulating film attached to coil plate 234 is damaged in some cases. That is, a pressurized portion serves as a power point and a contact portion serves as a working point. Thus, this force is applied from corner 238 to the end face of coil plate 234. For this reason, if corner 238 has an acute angle, a force is applied to only coil plate 240, coming into contact with corner 238, in the width direction. As a result, there is a possibility that the insulating film is dropped or peeled off.

On the other hand, in this embodiment, corner 238 is formed smoothly as shown in FIG. 22. Thus, coil plate 234, to which a pressure is applied from both sides thereof in the radial direction, is deformed along corner 238 formed smoothly. By application of such pressure, therefore, a force is applied to the end face of coil plate 234 from the entire face of corner 238 formed smoothly. Since a force is not applied in a centralized manner, but is applied in a decentralized manner, insulating film 242 attached to coil plate 234 is prevented from being damaged or peeled off.

Moreover, the joining face of the end of the coil plate in the longitudinal direction is formed into a step shape so as to decrease a thickness thereof. In this embodiment, there is shown a fixed thickness of a joining face formed at an end of a coil plate in a longitudinal direction. More preferably, such joining face is formed so as to gradually decrease a thickness toward the end.

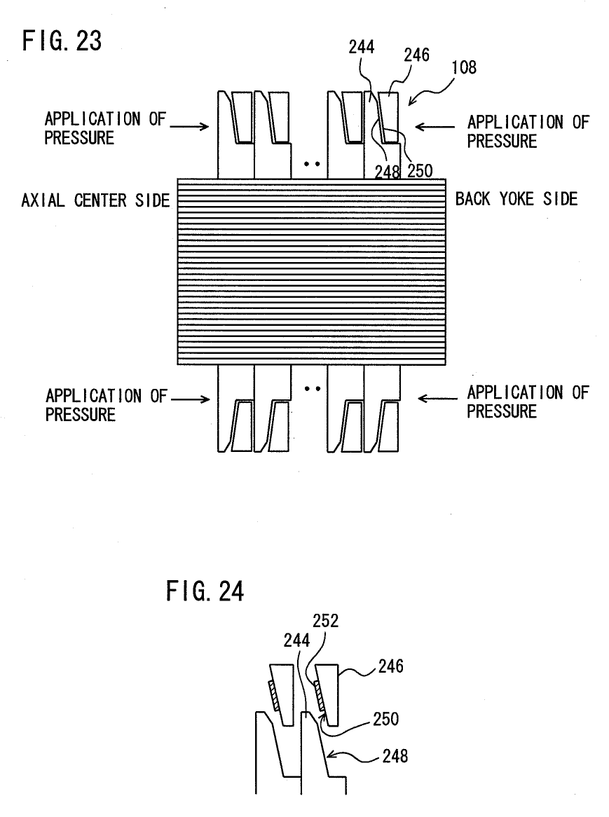

That is, as shown in FIG. 23, in a coil sub-assy 108, a step-shaped joining face 248 is formed at an end of a coil plate 244 in an axial direction (vertical direction in FIG. 23) so as to decrease a thickness thereof. Further, joining face 248 is tapered so as to gradually decrease a thickness thereof toward the end of coil plate 244.

Each of joining faces 250 on both ends of a coil end plate 246 is formed into such a shape that joining face 250 comes into contact with joining face 248 without being slid when coil end plate 246 is mounted to coil plate 244 in the vertical direction in FIG. 23. In this embodiment, each of the both ends of coil end plate 246 is tapered such that the thickness of joining face 250 is gradually decreased in a downward direction of FIG. 23.

As shown in FIG. 24, a silver nanoparticle paste 252 is applied to each of the both ends of coil end plate 246. In a case that coil end plate 246 is inserted into coil plate 244 such that joining face 250 and joining face 248 slide each other, there is a possibility that silver nanoparticle paste 252 is dropped or peeled off. On the other hand, the end of coil end plate 246 and that of coil plate 244 are tapered. Thus, joining face 250 comes into contact with joining face 248 without sliding on joining face 248 in a case that coil end plate 246 is mounted to coil plate 244 while being moved in a predetermined direction with respect to coil plate 244 (longitudinal direction of coil plate 244 in this embodiment). Therefore, silver nanoparticle paste 252 applied to coil end plate 246 is prevented from being dropped or peeled off.

This embodiment also has a feature in that a coil end plate is chamfered.

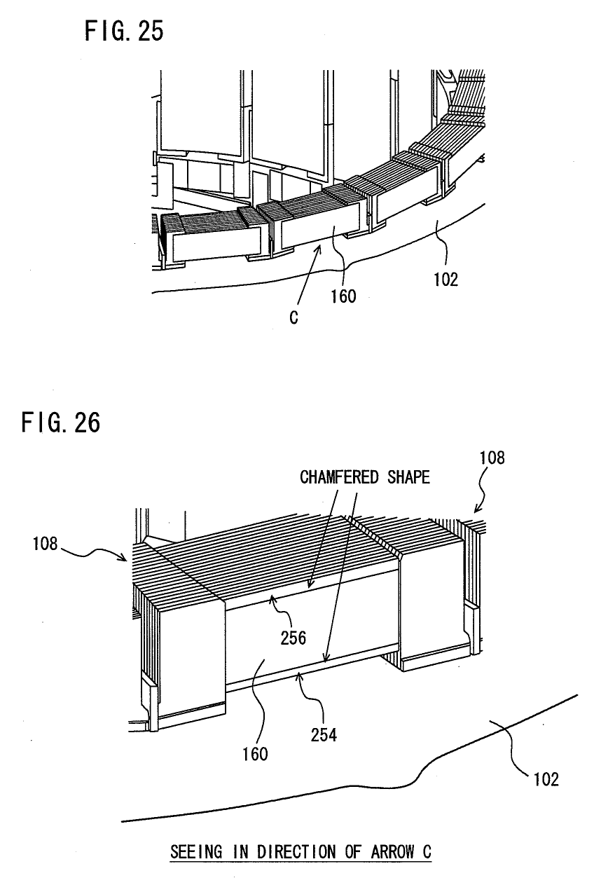

As shown in FIG. 25, coil end plates 160 are laminated in the radial direction of stator core 102. Accordingly, if a shortest distance between end faces of coil end plate 160 in the width direction is shorter than an electric discharge start distance, there is a possibility that electric discharge occurs between coil end plates opposite to each other (between turns). That is, there is a possibility that an insulating property between coil end plates is deteriorated.

In order to avoid such disadvantage, as shown in FIG. 26, chamfered shapes 254 and 256 are formed at corners of a coil end plate 160 in the width direction (vertical direction in FIG. 25), so that a shortest distance and a creepage distance between coil end plates opposite to each other are extended. Preferably, such chamfered shape is formed on coil end plate 160 on the back yoke side. For the sake of description, a retaining member 158 is not shown in FIGS. 25 and 26.

In place of the chamfered shape, a step shape may be formed on coil end plate 160. Even when the step shape is formed on coil end plate 160, the shortest distance between the end faces of the coil end plate, opposite to each other, in the width direction is extended. Thus, the creepage distance between the end faces of the coil end plates, opposite to each other, in the width direction is also extended. Accordingly, deterioration in insulating property between coil end plates can be suppressed.

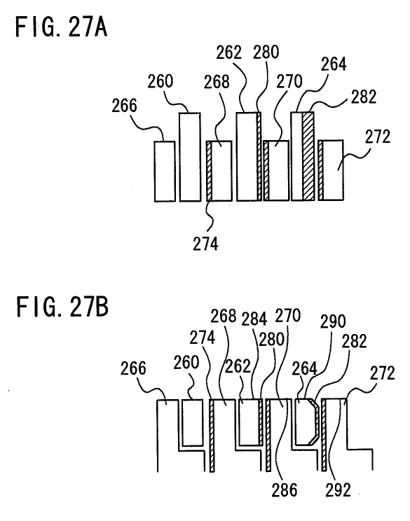

FIGS. 27A and 27B show a coil end plate 60 on which no chamfered shape is formed and to which no insulating film is attached, a coil end plate 262 on which no chamfered shape is formed and to which an insulating film is attached, and a coil end plate 264 on which a chamfered shape is formed and to which an insulating film is attached.

As shown in FIG. 27A, it is assumed that coil end plate 260 on which no chamfered shape is formed and to which no insulating film is attached is mounted to a coil plate 266. Herein, there is a portion in which an insulating film 274 is not interposed between coil end plate 260 and a coil plate 268 adjoining to coil end plate 260. Therefore, a creepage distance between coil end plate 260 and coil plate 268 is equal to a distance between opposing end faces of coil end plate 260 and coil plate 268. Accordingly, there is a possibility that an insulating property is deteriorated by occurrence of electric discharge as indicated by a path shown with a broken line in FIG. 27A.

As shown in FIG. 27A, moreover, it is assumed that coil end plate 262 on which no chamfered shape is formed and to which an insulating film 280 is attached is mounted to coil plate 268. Herein, insulating film 280 is attached to an adjoining coil plate 270 which is different from coil plate 268 to be joined. Since insulating film 280 is interposed between coil end plate 262 and coil plate 270, occurrence of the electric discharge as indicated by the path shown with the broken line in FIG. 27A is suppressed.

As shown in FIG. 27B, however, a shortest distance between end faces 284 and 286 of coil end plate 262 and coil plate 270 in the axial direction (vertical direction in FIG. 27B) is substantially equal to a shortest distance between opposing end faces of coil end plate 252 and coil plate 270. That is, there is a possibility that an insulating property is deteriorated by occurrence of electric discharge as indicated by a path shown with a broken line in FIG. 27B.

As illustrated in FIG. 27A, it is assumed that coil end plate 264 on which a chamfered shape 288 is formed and to which an insulating film 282 is attached is mounted to coil plate 270. Herein, insulating film 282 is attached to an adjoining coil plate 272 which is different from coil plate 270 to be joined. Since insulating film 282 is interposed between coil end plate 264 and coil plate 272, occurrence of the electric discharge indicated by the path shown with the broken line in FIG. 27A is suppressed.

As shown in FIG. 27B, further, a shortest distance between an end face 290 of coil end plate 264 and an end face 292 of coil plate 272 in the axial direction is longer than a shortest distance between opposing end faces of coil end plate 264 and coil plate 272 by the formation of the chamfered shape. Accordingly, the chamfered shape is formed such that a creepage distance between end faces 290 and 292 is longer than a distance of occurrence of electric discharge between coil end plate 264 and coil plate 272; thus, occurrence of the electric discharge indicated by the path shown with the broken line in FIG. 27B is suppressed.

As described above, with the stator of the rotating electric machine according to this embodiment, a chamfered shape or a step shape is formed on a coil plate in a longitudinal direction such that a shortest distance between end faces in a width direction is longer than a shortest distance between end faces in a thickness direction, so that a distance between the end faces in the width direction (shortest distance and creepage distance) is extended. Thus, an insulating property can be secured. Further, even when a burr generated in copper plate machining is attached to a coil plate or an insulating film or a thickness of the insulating film varies due to joining, the extended distance is secured. Therefore, it is possible to prevent occurrence of a short circuit and to suppress deterioration in insulating property. Thus, it is possible to provide a stator of a rotating electric machine capable of improving a space factor and achieving insulation in a coil.

Moreover, it is possible to verify an interphase insulation state of a plurality of coil plates retained by a resin insulator prior to an operation for mounting the resin insulator to a slot of a stator core. In other words, it becomes unnecessary to conduct a verification after the operation for mounting the resin insulator to the slot. Thus, it is possible to suppress generation of defectives about insulation on a stator basis. Accordingly, it is possible to suppress an increase in cost.

Further, a corner of a coil plate, which comes into contact with an end face of an opposing coil plate in a width direction, is formed smoothly. Even when the opposing coil plate is warped, the corner of the coil plate hinders concentration of a force on the warped coil plate. Therefore, it is possible to prevent an insulating film attached to the coil plate from being dropped or peeled off.

Further, a step-shaped end of a coil plate is formed into a tapered shape so as to gradually decrease a thickness of a joining face toward the end. With this configuration, in a case that a coil end plate is mounted to the end of the coil plate, the joining face is not parallel with the inserting direction of the coil end plate. Therefore, there is no possibility that the joining faces of the coil plate and the coil end plate slide each other. Since the joining faces are prevented from sliding each other, a silver nanoparticle paste to be applied to one of the joining faces of the coil plate and the coil end plate can be prevented from being dropped or peeled off.

Further, an end of a coil plate is joined to a coil end plate through a paste-like joining material containing silver nanoparticles each coated with an organic substance and an organic solvent. In the joining material, when the organic substance serving as a protection layer is decomposed by application of heat, sintering of the silver nanoparticles is commenced at a low temperature. Therefore, the sintering temperature can be made lower than a melting temperature of an insulating material. On the other hand, the sintered silver nanoparticles are in a metal bonded state, and are not melted until a time when the temperature is increased to an eutectic temperature of the silver with the material for the coil plate (for example, about 1000° C. in case of using silver and copper). Using such joining material, the temperature in the joining operation is lower than the melting temperature of the insulating material, so that deterioration in the insulating performance of the insulating member can be suppressed. After the joining operation, further, the melting temperature at the joint is sufficiently higher than heat generated upon actuation of a rotating electric machine, so that deterioration in joining strength can be suppressed.

Further, a chamfered shape is formed on a coil end plate in a longitudinal direction. Thus, it is possible to extend a creepage distance between coil end plates. In addition, it is possible to extend a creepage distance between a coil end plate and a coil plate. Accordingly, each of the creepage distance between the coil end plates and the creepage distance between the coil end plate and the coil plate becomes longer than an electric discharge start distance. Thus, an insulating property can be secured.

Further, even when a burr generated in copper plate machining is interposed between coil end plates or is interposed between a coil end plate and a coil plate, the extended distance by the chamfered shape is secured. As a result, it is possible to prevent a short circuit and to suppress deterioration in insulating property.

A joining material is applied to each of both ends of a coil end plate. Therefore, it is possible to avoid insulation failure due to dropping or peeling of such joining material until a time when the coil end plate is mounted to a coil plate. Thus, it is possible to improve reliability about insulation.

It should be noted that the embodiments disclosed herein should be understood as being illustrative rather than limitative in all respects. The scope of the present invention is indicated by the appended claims rather than by the foregoing description and all changes which come within the meaning and range of equivalency of the claims are therefore intended to be embraced therein.

1. A component for use in a stator, comprising a coil plate having an insulating member attached to at least one side thereof and an “I”-shaped portion to be inserted into a slot of a stator core, wherein
said plurality of coil plates forming coils of an identical phase are laminated in a thickness direction of said “I”-shaped portions, and
said coil plates opposite to each other are formed such that a shortest distance between end faces of said “I”-shaped portions in a width direction is longer than a shortest distance between end faces of said “I”-shaped portions in the thickness direction.

2. The component for use in the stator according to claim 1, wherein
said “I”-shaped portion of said coil plate is formed into a chamfered shape in a longitudinal direction.

3. The component for use in the stator according to claim 1, wherein
said “I”-shaped portion of said coil plate is formed into a step shape in a longitudinal direction.

4. The component for use in the stator according to claim 1, wherein
said coil plate is a coil plate formed into an “I” shape,
said component further comprises an insulated retaining member for integrally retaining said laminated coil plates forming the coils of the identical phase, and
said insulated retaining member retains laminated coil plates of different phases to be inserted into said identical slot.

5. The component for use in the stator according to claim 1, wherein
said coil plate has an end provided with a step-shaped joining face so as to decrease a thickness thereof, and
a corner of the coil plate, which comes into contact with an end face of the opposing coil plate in the width direction, is formed smoothly.

6. The component for use in the stator according to claim 1, wherein
said coil plate has an end provided with a step-shaped joining face so as to decrease a thickness thereof, and
said coil plate has a tapered shape so as to gradually decrease a thickness of said joining face toward the end.

7. A stator of a rotating electric machine including a rotor and such stator, comprising:
a stator core having a plurality of slots formed in parallel with a rotational axis of said rotating electric machine; and
a coil plate laminate having a configuration that a plurality of coil plates each having an insulating member attached to at least one side thereof are laminated in a radial direction, wherein
said coil plate has an “I”-shaped portion to be inserted into said slot, and
said coil plates opposite to each other are formed such that a shortest distance between end faces of said “I”-shaped portions in a width direction is longer than a shortest distance between end faces of said “I”-shaped portions in the thickness direction.

8. The stator of the rotating electric machine according to claim 7, wherein
said “I”-shaped portion of said coil plate is formed into a chamfered shape in a longitudinal direction.

9. The stator of the rotating electric machine according to claim 7, wherein
said “I”-shaped portion of said coil plate is formed into a step shape in a longitudinal direction.

10. The stator of the rotating electric machine according to claim 7, wherein
said coil plate is a coil plate formed into an “I” shape,
said coil plate laminate further includes an insulated retaining member for integrally retaining said laminated coil plates forming the coils of the identical phase, and
said insulated retaining member retains laminated coil plates of different phases to be inserted into said identical slot.

11. The stator of the rotating electric machine according to claim 7, wherein
said coil plate has an end provided with a step-shaped joining face so as to decrease a thickness thereof, and
a corner of the coil plate, which comes into contact with an end face of the opposing coil plate in the width direction, is formed smoothly.

12. The stator of the rotating electric machine according to claim 7, wherein
said coil plate has an end provided with a step-shaped joining face so as to decrease a thickness thereof, and
said coil plate has a tapered shape so as to gradually decrease a thickness of said joining face toward the end.

13. The stator of the rotating electric machine according to claim 7, wherein
said stator further comprises a connection member for connecting between coil plate laminates inserted into different slots, respectively, and
said coil plate is joined to said connection member through a paste-like joining material containing metal nanoparticles each coated with an organic substance and an organic solvent.

14. The stator of the rotating electric machine according to claim 13, wherein
said connection member has ends in a longitudinal direction each provided with a flat face coming into contact with the joining face formed on said coil plate when said connection member is mounted to said coil plate while being moved in a predetermined direction with respect to said coil plate.

15. The stator of the rotating electric machine according to claim 13, wherein
said connection member is a coil end plate for connecting between coil plate laminates inserted into adjoining slots, respectively, and
said coil end plate has an end face opposite to a portion coming into contact with the joining face of said coil plate, the end face being formed into a chamfered shape in the longitudinal direction.

16. The stator of the rotating electric machine according to claim 13, wherein
said joining material is applied to said connection member.

17. The component for use in the stator according to claim 1, wherein
said insulating member is attached to an end face of said coil plate in a laminating direction.

18. The stator of the rotating electric machine according to claim 7, wherein
said insulating member is attached to an end face of said coil plate in a laminating direction.
